(19) United States
(12) Patent Application Publication
(10) Pub. No.: US 2008/0244145 A1
(43) Pub. Date: Oct. 2, 2008

(54) Data storage docking system

(75) Inventors: James R. Kramlich, Oakdale, MN (US); Stephen H. Dwyer, Woodbury, MN (US); Yung Yip, Afton, MN (US)

Correspondence Address: Attention: Eric D. Levinson;Imation Corp., Legal Affairs, P.O. Box 64898, St Paul, MN, 55164-0898, US

(73) Assignee: Imation Corp.

(21) Appl. No.: 11/731,583

(22) Filed: Mar. 30, 2007

(51) Int. Cl. G06F 13/10; G06F 1/16

(52) U.S. Cl. 710/304; 710/303

(57) ABSTRACT

A docking system for interfacing with a host computing device and for receiving a plurality of data storage components including a non-tape data storage media and an electrical contact. The docking system includes a primary station and an auxiliary station. The primary station includes an electrical connection device configured to interface with the host computing device and a primary station electrical coupling element. The auxiliary station includes a corresponding electrical coupling element selectively coupled with the primary station electrical coupling element and further includes at least one socket configured to selectively receive one of the plurality of data storage components. The docking system is configured to provide the host computing device with access to the non-tape data storage media via the electrical connection device, the primary station electrical coupling element, the corresponding electrical coupling element of the auxiliary station, and the electrical receptor of the auxiliary station.

### BACKGROUND OF THE INVENTION

In both personal and business arenas, the need for reliable and sizable data storage continues to increase and evolve. One aspect of this evolution in storage has been a steadily increasing demand for portable data storage (e.g., memory devices). In particular, individuals or business entities often have computer systems that are unable to support the memory required for certain use of the computer, and/or a user may wish to simply remove or back up data stored in the memory of the computer system. Similar needs exist with respect to networked systems requiring periodic back up or supplemental storage solutions. Such needs are specifically noticeable for computing systems requiring more storage than is generally available on the computer system itself, but not requiring sufficient storage to justify the expense of a conventional data storage library.

One option of removable data storage is a hard disk drive contained within a cartridge. The hard disk drives are typically stored in a larger shell or cartridge including isolating materials to protect the hard disk drive from contaminates or from shock or other inadvertent vibrations introduced to the cartridge (e.g., such as shock introduced from a free fall of the cartridge onto a hard surface). The hard disk drive cartridge removably interfaces with the computer system via a docking station or by being received by the computer housing itself. Typical external docking systems provide a single reception slot for receiving a hard disk drive cartridge. In this manner, where the capacity of more than one hard disk drive cartridge is desired, multiple docking systems must be provided and are each individually associated with the computer system. Such arrangements generally require an undesirable amount of desktop space and introduce an undesirable web of interface cords, cables, etc. running between the various docking systems and the computer system.

For at least the above reasons, it would be desirable to create a device/system for cost effectively using portable storage media for increased capacity applications, which utilizes a small desktop footprint and provides for a simple connection with the associated computer system.

### SUMMARY OF THE INVENTION

One aspect of the invention relates to a docking system for interfacing with a host computing device and for receiving a plurality of data storage components. Each of the plurality of data storage components includes a non-tape data storage media and an electrical contact providing external access to the non-tape data storage media. The docking system includes a primary station and an auxiliary station. The primary station includes an electrical connection device configured to interface with the host computing device and a primary station electrical coupling element. The auxiliary station is formed separately from the primary station and includes a corresponding electrical coupling element selectively coupled with the primary station electrical coupling element. The auxiliary station further includes at least one socket configured to selectively receive one of the plurality of data storage components and an electrical receptor positioned within each socket. The electrical receptor is configured to interface with the electrical contact of the one of the plurality of data storage components received by the socket. As such, the docking system is configured to provide the host computing device with access to the non-tape data storage media via the electrical connection device, the primary station electrical coupling element, the corresponding electrical coupling element of the auxiliary station, and the electrical receptor of the auxiliary station.

### BRIEF DESCRIPTION OF THE DRAWINGS

FIG. 1 is a perspective view illustrating one embodiment of a docking system with non-tape data storage cartridges.

FIG. 2 is a perspective view illustrating the non-tape data storage cartridge of FIG. 1 as viewed from an opposite side thereof.

FIG. 3 is a perspective view illustrating one embodiment of an auxiliary docking station of FIG. 1 as viewed from an opposite side thereof.

FIG. 4 is a perspective view illustrating one embodiment of a docking system with a plurality of non-tape data storage cartridges.

FIG. 5 is a flow chart illustrating one embodiment of a method of using the docking station of FIG. 4 to aggregate storage.

FIG. 6 is a flow chart illustrating one embodiment of a method of using the docking station of FIG. 4 to allocate storage.

### DETAILED DESCRIPTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

An external docking system of the present invention is configured to selectively receive a plurality of data storage components while using a reduced number of interface devices to communicate with a host computing system. In one embodiment, the external docking system makes use of a single host interface cable to communicate with the host computing system. In one embodiment, the docking system includes a primary station and at least one auxiliary station each configured to receive one or more data storage components and to be selectively coupled with one another. The primary station includes an interface device to communicate with the host computing system. The auxiliary station is configured to mechanically and electrically be selectively coupled with the primary station to expand the capacity of the docking system without introducing additional interface devices to be coupled with the host computing device. In one example, additional auxiliary stations can be coupled to the original auxiliary station or to the primary station. As such, the external docking system provides for increased and/or customizable data storage capacity while simultaneously providing for a more user-friendly installation with respect to the host computing device.

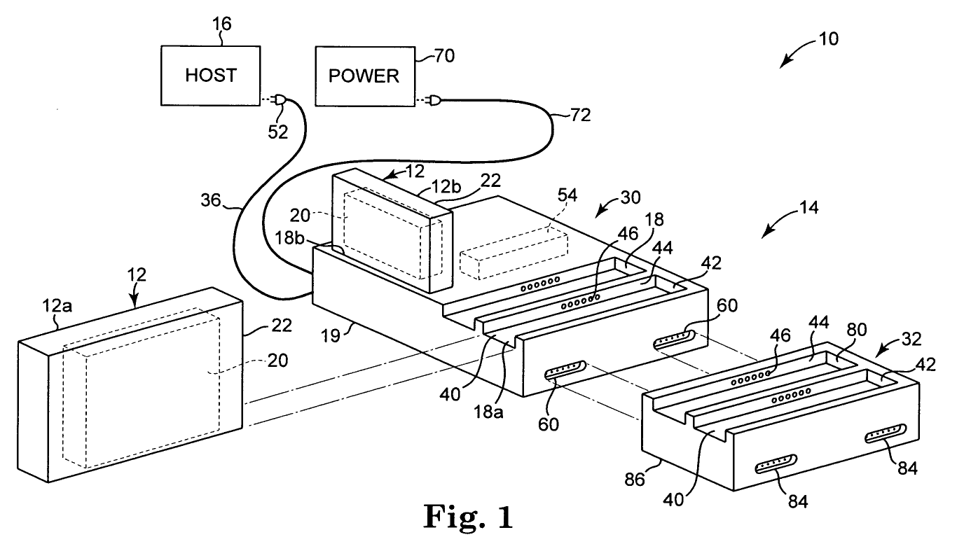

Turning to the figures, FIG. 1 illustrates one embodiment of a storage system 10 including one or more data storage components 12, a docking system 14, and a host computing device generally indicated at 16. In one embodiment, the docking system 14 includes sockets 18 configured to selectively receive and to facilitate electronic access to the one or more data storage components 12. Accordingly, the docking system 14 is also coupled with the host computing device 16 to, thereby, facilitate data exchange or other communication between the host computing device 16 and the data storage components 12. In one embodiment, the data storage capacity of the docking system 14, which includes the number of the data storage components 12 the docking system 14 is configured to receive, is adjustable such that the docking system 14 can be customized to meet the storage needs of one using the storage system 10.

The host computing device 16 is any suitable computing device for use with the docking system 14 as will be apparent to those of skill in the art upon reading this application. In one embodiment, the host computing device 16 is a stand-alone computing unit. In one embodiment, the host computing device 16 is a network drive such that the docking system 14 can be plugged therein to function as a networked drive(s) accessible by multiple users, etc.

### Data Storage Components

In one embodiment, each data storage component 12 includes data storage media or memory, which is generally indicated at 20 in FIG. 1. The memory 20 may take the form of any non-tape storage medium and, for example, may include one or more of a variety of storage media such as a disk-shaped magnetic storage medium (e.g., a hard disk drive), a solid-state storage medium, an optical storage medium, a magneto-optical storage medium, and a holographic storage medium. In one embodiment where the memory 20 is a solid state storage medium, the memory 20 includes any non-volatile memory such as an erasable programmable read-only memory (EPROM), an electrically erasable programmable memories (e.g., FLASH) memory or the like. In one embodiment, the memory 20 is a random access storage medium. In one embodiment, the primary station 30 is configured to receive various data storage components 12a and 12b, which may each be separate memory types, cartridge size, and/or may correspond with differently-shaped sockets (e.g., sockets 18a, 18b), etc. For example, in one embodiment, data storage component 12a has a memory 20 that is a hard disk drive while data storage component 12b has a memory 20 that is a FLASH memory.

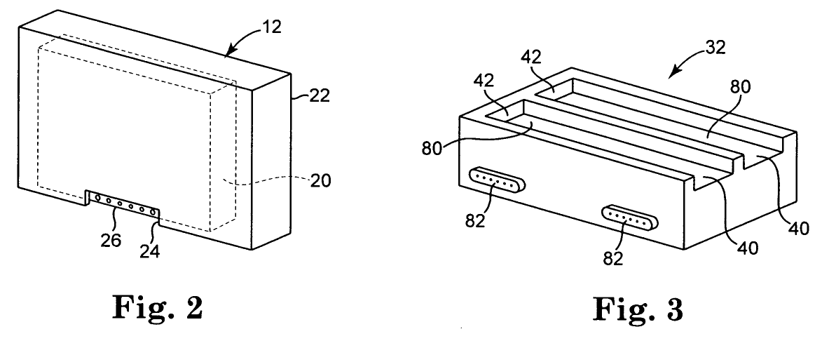

To improve the handling characteristics thereof, in one example, the data storage component 12 includes a housing or cartridge 22 supporting and at least partially enclosing the memory 20. The cartridge 22 is formed in any suitable size and shape configured to hold, and, in one example, fully enclose, the memory 20 and to be received by one of the sockets 18. Additionally referring to FIG. 2, which illustrates an opposite side of the data storage component 12 as illustrated in FIG. 1, in one embodiment, the cartridge 22 is substantially rectangular and includes an opening or other access area 24 to an electrical data connector 26 mounted in and/or on the cartridge 22 and in electrical communication with the memory 20. The electrical data connector 26 may be any suitable data connector such as a Serial Advanced Technology Attachment (SATA) connector, Universal Serial Bus (USB) connector, an IEEE 1394 interface connector (e.g., a FireWire® connector available from Apple Inc. of Cupertino, Calif.), conductive target pads (for example, the targets described in U.S. patent application Ser. No. 11/502,254 entitled “Data Storage Cartridge with Hard Drive and Electrical Targets,” filed Aug. 9, 2006, the contents of which are herein incorporated by reference), etc. In one embodiment, data storage component 12 is an Odyssey cartridge with hard disk drive memory available from Imation Corp. of Oakdale, Minn.

### Docking System

In one embodiment, the docking system 14 includes a primary station 30 and one or more auxiliary stations 32 configured to be selectively coupled with one another to adjust the number of the data storage components 12 that can be received by the docking system 14.

Primary Station

More specifically, the primary station 30 includes one or more of the sockets 18 each configured to selectively receive one of the data storage components 12 and provides an electrical interface device 36 with host computing device 16 such that the host computing device 16 can access data stored by and/or write data to the data storage component 12, more particularly, the memory 20, via the electrical interface device 36 and primary station 30. Although illustrated in FIG. 1 as including two sockets 18, the primary station 30 may include any suitable number of sockets 18.

Each of the sockets 18 of the primary station 30 may be formed of any suitable size and shape to fully or partially receive one of the data storage components 12. As illustrated in FIG. 1, in one embodiment, each socket 18 is substantially a rectangular slot with an open end 40 such that the data storage component 12 can be slid into the respective socket 18 through the open end 40 toward an opposite socket end 42. In one instance, each socket 18 is formed opposite a support surface 19 of the primary station 30 such that each socket 18 is accessible from a top of the primary station 30 when the support surface 19 is placed on a desktop or other support surface.

In one example, an internal surface 44 is defined within each socket 18. The internal surface 44 or other suitable portion of the socket 18 defines an electrical receptacle or other suitable electrical interface generally indicated at 46 configured to selectively interface with the electrical data connector 26 (FIG. 2) of the data storage component 12. The electrical receptacle 46 may be any suitable connector configured to interface with the particular electrical data connector 26 of the data storage component 12 described above. In one example, the electrical receptacle 46 is configured to automatically align and mate with the electrical data connector 26 of the data storage component 12 when the data storage component 12 is fully slid into the socket 18.

Although one embodiment of the socket 18 with electrical receptacle 46 is illustrated and described, it should be understood that various other sockets and electrical receptacle designs included therein are also contemplated such as a socket without an open end that is configured to receive a data storage component 12 that is “dropped” therein, a socket that fully enclosed the data storage components, etc., or any suitable combination thereof. For example, in one embodiment, two different socket types 18a and 18b are provided where each socket type 18a and 18b is configured to receive a corresponding data storage component 12a and 12b, respectively.

As introduced above, the primary station 30 includes the electrical interface device 36. In one embodiment, the electrical interface device 36 is any suitable interface device, such as a host interface cable, and includes a plug 52, etc., configured to couple the docking station 14 to the host computing device 16. In one embodiment, only the primary station 30 is directly coupled with the host computing device 16 via the electrical interface device 36 and the auxiliary station 32 is only coupled with the host computing device 16 via the primary station 30. In this manner, in one embodiment, the addition of one or more auxiliary stations 32 to the storage system 10 does not increase the number of electrical interface devices 36 that are coupled with the host computing device 16.

In one embodiment, the plug 52 of the electrical interface device 36 is of a standard type not specifically designed for use with the docking system 14. For example, the plug 52 may include any one of a USB connector, SATA connector, IEEE 1394 connector, small computer system interface (SCSI) connector, serial attached SCSI (SAS) connector, Ethernet connector or other suitable plug or connector configured to interface with a standard connection receptacle (not shown) of the host computing device 16. In this manner, the docking system 14 can be used with host computing devices 16 even where such host computing devices 16 are not specifically designed for use with the particular docking system 14.

In one embodiment, the primary station 30 additionally includes a chip or processor 54 or other suitable device configured to facilitate communication between the host computing device 16 and any data storage components 12 in communication therewith. For example, in one embodiment, processor 54 is configured to provide a specific presentation of the data storage components 12 maintained by the docking system 14 to the host computing device 16 and/or to facilitate allocation of data to/from the host computing device 16 and the data storage components 12. In one embodiment, in which the docking system 14 is being used to aggregate the storage capacity of the data storage components 12 received by the docking system 14, the processor 54 is configured to present the docking system 14 to the host computing device 16 as a single storage unit with a capacity dependent upon the number and individual storage capacity of the data storage components 12 docked thereto. In one embodiment, where the docking system 14 is being used to facilitate allocation of storage, the processor 54 is configured to function similar to a USB Hub device to present each individual data storage component 12 docketed thereto as a separate drive (e.g., as an F drive, G drive, H drive, etc.). Each of the storage aggregation and the storage allocation uses of the docking system 14 will be further described below.

Primary station 30 additionally includes one or more primary station coupling elements 60. Each coupling element 60 is configured to interact with an auxiliary station 32 to at least one of mechanically and electrically interface with the auxiliary station 32. For instance, as generally illustrated in FIG. 1, the coupling element 60 is configured to provide both mechanical alignment of and electrical coupling of the primary station 30 to the auxiliary station 32 as will be further described below. In one example, at least some of the coupling elements 60 make use of and include a standard electrical connection, such as USB, SATA, IEEE 1394 interface, etc. In one embodiment, the coupling element 60 is coupled with the processor 54 such that the processor 54 is configured to automatically detect when an auxiliary station 32 is coupled with the primary station 30. In one example, the primary station 30 is configured to permit removal and addition of the data storage components 12 with automatic detection, in other words, “hot swapping,” of the data storage components 12.

In one embodiment, connection with the host computing device 16 provides the primary station 30 with sufficient power to function in a desirable manner. However, in one embodiment, the electrical interface device 36 does not provide the primary station 30 with sufficient power to function as described above and below. In such embodiments, a power supply 70 is provided and placed in communication with the primary station 30. The power supply 70 may solely provide power to or may provide power in addition to power supplied via the electrical interface device 36 from the host computing device 16 to the primary station 30. The power supply 70 may be an alternating or direct current power supply coupled with the primary station 30 via a power cord or interface 72 included with the primary station 30. Use of additional or alternative power supplies, such as internal or externally mounted batteries, etc., is also contemplated.

Auxiliary Station(s)

As alluded to above, the auxiliary station 32 is configured to be selectively coupled with the primary station 30 to provide additional capacity to the docking system 14 for receiving data storage components 12. In one embodiment, auxiliary station 32 includes one or more sockets 80 similar to sockets 18 of primary station 30 described above. As such, in one example, each socket 80 of auxiliary station 32 may be formed of any suitable size and shape to fully or partially receive one of the data storage components 12. As illustrated in FIG. 1, in one embodiment, each of the sockets 80 is substantially a rectangular slot defining the open end 40 such that the data storage component 12 can be slid into the respective socket 80 through the open end 40 toward the opposite socket end 42. In one instance, each socket 80 is formed opposite a support surface 86 of the auxiliary station 32 such that each socket 80 is accessible from a top of the auxiliary station 32 when the support surface 86 is placed on a desktop or other support surface. In one embodiment, the one or more sockets 80 and/or the one or more sockets 18 are each a plurality of auxiliary sockets or a plurality of primary station sockets, respectively. In one example, the sockets 80 and 18 collectively define a plurality of system sockets.

In one example, each socket 80 defines the internal surface 44. The internal surface 44 or other suitable portion of the socket 80 defines an electrical receptacle 46 configured to selectively interface with the electrical data connector 26 (FIG. 2) of the respective data storage component 12. The electrical receptacle 46 may be any suitable connector configured to interface with the particular electrical data connector 26 of the data storage components 12 described above. In one example, the electrical receptacle 46 is configured to automatically align and mate with the electrical data connector 26 of a respective data storage component 12 as the data storage component 12 is slid into the socket 80. In view of the above, in one embodiment, where each of the data storage components 12 has the same individual capacity, each auxiliary station 32 is configured to increase the capacity of the docking system 14 by the number of filled sockets 80 included therein times the individual storage capacity of the corresponding data storage components 12 that are received by the sockets 80.

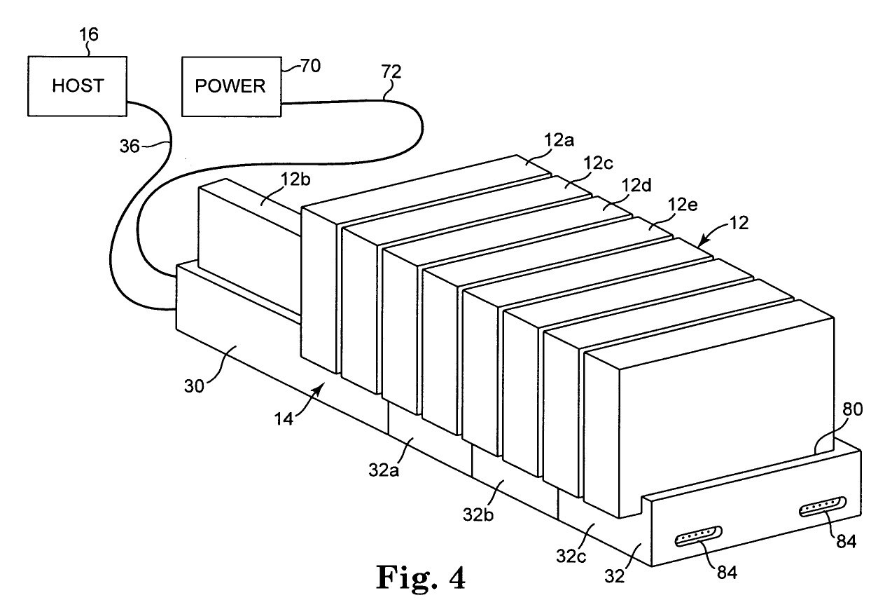

Additionally referring to FIG. 3, which shows an opposite side of the auxiliary station of FIG. 1, the auxiliary station 32 includes one or more corresponding coupling elements 82 configured to electrically and/or mechanically interface with the primary station coupling elements 60. In one embodiment, each corresponding coupling element 82 is configured to interface with a respective one of the primary coupling features to fully or at least partially align, mechanically couple, and/or electrically couple the primary station 30 with the auxiliary station 32. In one embodiment, the electrical coupling of the primary station 30 with the auxiliary station 32 provides the docking system 14 with additional capacity such that the processor 54 treats the additional sockets 80 of the auxiliary station in the same manner as the sockets 18 of the primary station 30.

In one embodiment, the auxiliary station 32 includes one or more auxiliary coupling elements 84 similar to the primary station coupling elements 60 on an opposite side of the auxiliary station 32 as compared to the one or more corresponding elements 82. Each of the coupling elements 84 is configured to interact with yet another auxiliary station 32 (not shown), more particularly, with the corresponding coupling elements 82 thereof, to be at least one of mechanically aligned, mechanically coupled, and electrically coupled with the additional auxiliary station 32. For instance, as generally illustrated with additional reference to FIG. 4, the primary station coupling elements 60, the corresponding coupling elements 82, and the auxiliary elements 84 facilitate lateral stacking of the primary station 30 and a plurality of auxiliary stations 32 (e.g., 32a, 32b, 32c) to collectively provide a relatively high storage capacity docking system 14. In one example, the lateral stacking causes the footprint of the docking system 14 to increase with each additional auxiliary station 32 added thereto. In other examples, one or more auxiliary stations 32 can be coupled to each other and to the primary station 30 in any suitable manner, such as by vertical stacking or other arrangement as will be apparent to those of skill in the art upon reading this application.

In one embodiment, the one or more primary station coupling elements 60, the corresponding coupling elements 82, and the auxiliary coupling elements 84 electrically couple the primary station 30 with the one or more auxiliary stations 32 such that the processor 54 of the primary station 30 is configured to automatically detect when an additional auxiliary station 32 is added to the docking system 14 and/or when a new data storage component 12 is received thereby or removed therefrom. In one example, the primary station 30 is configured to permit removal and addition of data storage components 12 with automatic electrical detection thereof, in other words, “hot swapping” of the data storage components 12 from any of the primary station 30 and/or the one or more auxiliary stations 32. In one embodiment, only one or no auxiliary station 32 is coupled with primary station 30.

Referring to FIG. 4, any number of auxiliary stations 32 can be included in the docking system 14 as desired for a particular purpose or application. In other embodiments, the primary station 30 may include a desired number of sockets 18 such that no auxiliary station 32 is added. As illustrated in FIG. 4 in view of FIG. 1, the primary and auxiliary stations 30 and 32 are coupled together to allow for pass-through communication with the host computing device 16, and, in one embodiment, to allow for pass-through powering of each station 30 and 32 from the power supply 70. More specifically, for example, an auxiliary station 32c communicates with the host computing device 16 and/or receives power from power supply 70 via auxiliary stations 32a and 32b and the primary station 30 by way of the coupling elements 60, 82, and 84.

The resultant docking system 14 can be used for any number of purposes such as allocated and/or aggregated storage for back-up, high-storage volume activities, etc. Use of docking system 14 for allocated and aggregated storage are described in further detail below.

### Docking System Uses

Aggregated Storage

In one embodiment, the docking system 14 is configured to present the entirety of the data storage components 12 as a single drive, file, or other logical storage unit to the host computing device 16. In this manner, the docking system 14 is represented to the host computing device 16 as a single storage unit, not as a plurality of individual data storage components 12. Aggregated storage is particularly useful in application requiring large amounts of data storage and/or applications making use of data storage schemes with data shared or replicated across a plurality of data storage components 12 for security or other data protection reasons. In one embodiment, the docking system 14 is populated with a selected number of data storage components 12, for example, eight data storage components 12 as illustrated in FIG. 4 (however, it should be understood that use of any number of two or more data storage components 12 is contemplated for aggregated storage use). The processor 54 of the primary station 30 is configured to represent the plurality of data storage components 12 to the host computing device as a single mass storage device.

Any suitable storage scheme may be utilized with the docking system 14. In one embodiment, the docking system 14, more particularly, the processor 54 is specifically configured for a predetermined storage scheme, while in one embodiment, the user of the host computing device 16 and the docking system 14 can select the particular storage scheme. In one example, the storage scheme used to store data to the plurality of data storage components 12 is one of a plurality of RAID (Redundant Array of Inexpensive Disks) schemes including data striping without redundancy (RAID 0), mirroring (RAID 1), data striping with dedicated parity data storage component (RAID 3), block-level data striping with dedicated parity data storage component (RAID 4), and block-level data striping with distributed parity (RAID 5), etc. In one embodiment, the amount of data storage that the processor 54 represents to the host computing device 16 as being available is dependent not only upon the capacity of the individual data storage components 12, but also upon the particular storage scheme being utilized.

For example, where as illustrated in FIG. 4, eight data storage components 12 are included and where a RAID 0 data striping without redundancy data storage scheme is utilized, the processor 54 will represent the total storage capacity of the docking system as being a summation of the data storage capacity of each of the data storage components 12. For instance, where each of the data storage components 12 has a storage capacity of 100 GB, the processor 54 will represent the data storage capacity of the docking system 14 as 800 GB (8×100 GB).

However, in one example, where the eight data storage components 12 are included and where a RAID 1 mirroring data storage scheme is utilized, the processor 54 will represent the total storage capacity of the docking system 14 as being half that actually available since the other half of the available data capacity is used for redundant storage or mirroring of data storage. More specifically, where each of the data storage components 12 has a storage capacity of 100 GB, the processor 54 will represent the data storage capacity of the docking system 14 with eight data storage components 12 as having a data storage capacity of 400 GB (i.e., the total data storage capacity of the first four data storage components 12a, 12c, 12d, and 12e), where the other 400 GB of data storage capacity provided by the remaining data storage components 12 is dedicated for duplicate storage and does not represent additional available storage capacity.

Other storage calculations to be performed by the processor 54 in representing the available data storage capacity of the docking system 14 based on the data storage components 12 and the data storage scheme will be apparent to those of skill in the art upon reading this application. Use of parity or replication, for example, as used in RAID 1-5, provides for data security in case one of data storage components 12 is damaged, misplaced, stolen, or otherwise becomes unavailable. In such cases, the remaining data storage components 12 permit the missing data to be replicated or otherwise recovered such that no data is generally lost due to a mishap with a single one of the data storage components 12. In one embodiment, for example, where parity is used, once a group of data storage components 12 are used together in the docking system 14 (such as the eight data storage components 12 of FIG. 4), the group of data storage components 12 are maintained as a group and similarly used in future applications.

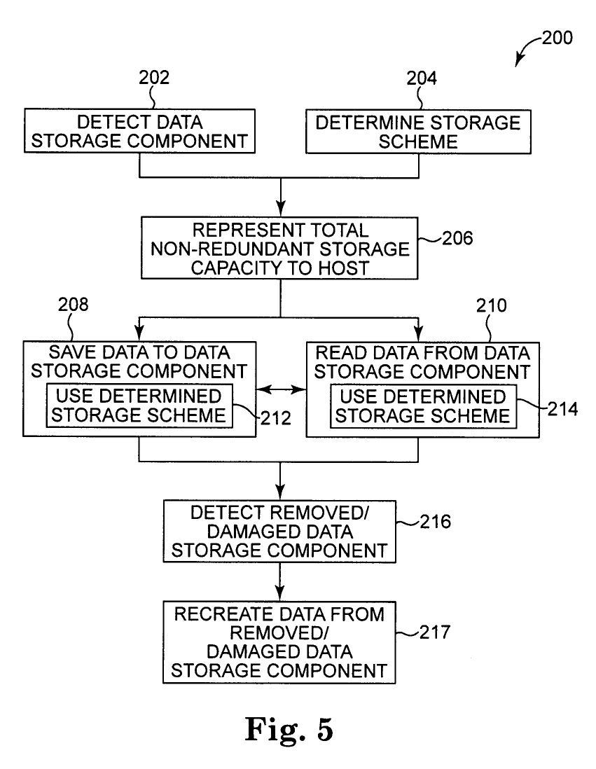

One embodiment of a generalized method of using the docking system 14 for aggregated storage is illustrated in FIG. 5 generally at 200. For instance, at 202, the docking system 14 detects the data storage components 12 that have been received within the sockets 18 and 80 thereof. In one example, detection at 202 includes detecting the storage capacity of each of the data storage components 12 received within the sockets 18 and 80. Using the information gained at 202 and the storage scheme determined from the processor 54 and/or the host computing device 16 at 204, then, at 206, the total non-redundant storage capacity of the docking system 14 is represented to the host computing device 16 (e.g., as described above with respect to RAID 0 and RAID 1, etc.).

Subsequently, at 208, data from the host computing device 16 can be saved or stored to the data storage components 12 and/or, at 210, data previously saved to the data storage components 12 can be accessed and sent to the host computing device 16. In one embodiment, data is saved to the data storage components 12 at 208 using the storage scheme determined at 204, as generally indicated at 212. Similarly, in one embodiment, data retrieved or read from the data storage components 12 at 210 is generally retrieved using the storage scheme at 214 as determined at 204 as will be apparent to those of skill in the art upon reading this application.

At 216, the docking system 14 or a user thereof, detects that one of the data storage components 12 has been removed or damaged. In one embodiment, the docking system 14 is configured to automatically detect such a change, while in other embodiments, the docking system 14 may need to be prompted by a user or the host computing device 16. Following a detection at 216, then, at 217, the docking system 14 can independently, or in concert with the host computing device 16, recreate or alternatively access data that was stored to the particular data storage component 12 determined to be removed or damaged at 217 using techniques that will be apparent to those of skill in the art upon reading this application. Other methods of using the docking system 14 for allocated storage are also contemplated.

Allocated Storage

In one embodiment, the docking system 14 is configured for allocated storage and, as such, presents each of the data storage components 12 as a separate individual drive, file, or other logical unit to the host computing device 16 (i.e., stores data to and reads data from the data storage components 12 on an individual drive basis). In this manner, the docking system 14 is represented to the host computing device 16 as providing a plurality of drives. For example, referring to FIG. 4, in an embodiment using allocated storage, the processor 54 will present each of the data storage components 12 maintained by the docking system 14 as a separate drive. More particularly, the data storage component 12a may be indicated to host computing device 16 as “Drive E,” the data storage component 12c may be indicated to host computing device 16 as “Drive F,” the data storage component 12d may be indicated to host computing device 16 as “Drive G,” and so on and so forth.

Such allocated storage allows for a plurality of data storage components 12 to communicate with the host computing device 16 as separate drives while only one electrical interface device 36 need be directly coupled with the host computing device 16. Further, since the docking system 14 neatly maintains each of the data storage components 12 at least partially therein, the footprint of the desktop used to maintain the data storage components 12 is decreased and the need for a separate hub or other device to present multiple drives to the host computing device 16 is decreased and/or eliminated. In addition, by providing each data storage component 12 as a separate drive, the data storage components 12 can be easily added to and/or removed from the docking system 14. In one embodiment, the data storage components 12 are electrically detected by the docking system 14 and are “hot swappable,” that is, can be added, removed, and/or interchanged while the docking system 14 is in use and/or otherwise in communication with the host computing device 16. In one embodiment, the docking system 14, more particularly, the processor 54, is configured to automatically update the host computing device 16 when data storage components 12 are added and/or removed from the docking system 14 by adding, removing, and/or otherwise updating the drive representation associated therewith.

Allocated storage is particularly useful in applications in which separate storage and organization of files is desired. For example, where host computing device 16 is used by multiple users, each data storage component 12 may correspond with a particular user (not shown). More specifically, a first user may be associated with the data storage component 12a, a second user may be associated with the data storage component 12c and so on. In this manner, all of the data associated with a particular user is stored in a single data storage component 12, which, in turn, is indicated as a separate drive to the host computing device 16. For instance, the first user can store and access all of their files, applications, etc. on data storage component 12a while the second user stores and accesses all of their files, applications, etc., on data storage component 12c, etc. Further, since the data storage components 12 are not permanently associated with one another, the first user can remove data storage component 12a without interrupting access to the other data storage components, such as 12c, 12d, etc., and transfer the data storage component 12a for transportation, use at another host computing device 16, etc.

Such allocated storage is also desirable in other applications. For instance, where the docking system 14 is used as a back-up storage system, each of the data storage components 12 may be designated as corresponding to a particular time period for which back-up information is stored thereto. For example, the data storage components 12 may each correspond with a different day in the week, a different week in a month, a different month in a year, etc., to facilitate a back-up regimen.

In one embodiment, allocated storage is useful in editing audio, visual, and multimedia files especially where relatively large volume files are used. For instance, different types of files or files taken at different venues, events, dates, etc., can each be allocated to a different data storage component 12 and, therefore, are each indicated as a separate drive to host computing device 16. Such categorical allocation facilitates a user in locating particular files or applications stored on the data storage components 12. Furthermore, since the data storage components 12 are “hot swappable,” the data storage components 12 are readily replaceable to access additional stored content without generally interrupting the overall editing process, etc. Other uses for allocated storage are also contemplated. In one embodiment, not only are the data storage components 12 hot swappable, but the auxiliary stations 32 are also hot swappable (i.e., can be removed, added, replaced, etc.) with respect to other auxiliary stations 32 and/or the primary station 30 without interrupting communication between the host computing device 16 and the primary station 30 and/or other auxiliary station(s) 32, which remain coupled to the primary station 30 while other auxiliary stations are swapped.

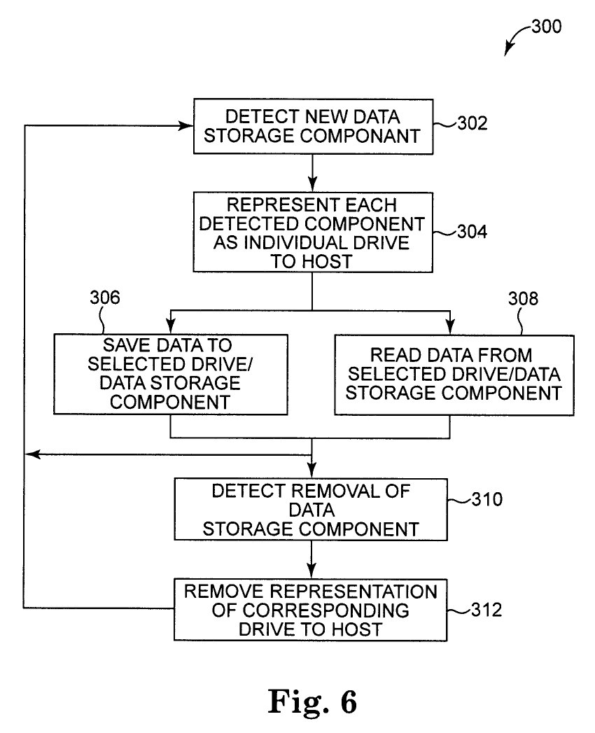

One embodiment of a generalized method of using the docking system 14 for allocated storage is illustrated in FIG. 6 generally at 300. For instance, at 302, the docking system 14 detects that one or more data storage components 12 have been received by the sockets 18 and/or 80 thereof. More specifically, as the data storage component 12 is slid into the respective socket 18 or 80, the electrical receptacle 46 of the socket 18 or 80 comes in contact with the electrical data connector 26 of the data storage component 12, for example, through the access area 24. Once an electrical connection is established between the electrical receptacle 46 and the electrical data connector 26, the docking system 14 detects the presence of the data storage component 12. In one example, detection at 302 includes detecting the storage capacity of each of the data storage components 12 received within the sockets 18 and/or 80. Once detected, then, at 304, the docking system 14, more particularly, the processor 54, represents a separate drive corresponding with each of the detected data storage components 12 to the host computing device 16.

Subsequently, at 306, data from the host computing device 16 is sent and stored to (i.e., saved to) the data storage components 12 as directed by the host computing device 16. In particular, host computing device 16 selects a drive that data is to be stored to, and based on that selection, the docking system 14 saves the data to a corresponding data storage component 12. The host computing device 16 may direct the storage of data to data storage components 12 at 306 in any desired allocation manner, for example, per one of the example allocation methods described above.

At 308, data previously saved to the data storage components 12 can be accessed and sent to the host computing device 16 for further use and/or processing. In one embodiment, data previously saved to the data storage components 12 at 306 can be accessed on a drive-by-drive (i.e., data storage component 12 by data storage component 12) basis. In this manner, files can be easily located due to the categorization of the data allocation as known to the host computing device 16 and/or the user operating the host computing device 16.

At 310, the docking system 14 automatically detects that one of the data storage components 12 has been removed from the docking system 14. Immediately following such detection at 310, then at 312, the docking system 14 updates the host computing device 16 to remove the drive representation corresponding with the data storage component 12 from the host computing device while not generally effecting the other drives (i.e., the representation of the other data storage components 12) to the host computing device. At any time during the method 300 that a new data storage component 12 is inserted into one of sockets 18 or 80 at 302, a new drive is represented to the host computing device 16 at 304, and the method 300 continues.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A docking system for interfacing with a host computing device and for receiving a plurality of data storage components, each of the plurality of data storage components including a non-tape data storage media and an electrical contact providing external access to the non-tape data storage media, the docking system comprising:
a primary station including an electrical connection device configured to interface with the host computing device, the primary station additionally including a primary station electrical coupling element; and
an auxiliary station formed separately from the primary station and including a corresponding electrical coupling element selectively coupled with the primary station electrical coupling element, the auxiliary station further including at least one socket configured to selectively receive one of the plurality of data storage components and an electrical receptor positioned within each socket and being configured to interface with the electrical contact of the one of the plurality of data storage components received by the socket,
wherein the docking system is configured to provide the host computing device with access to the non-tape data storage media via the electrical connection device, the primary station electrical coupling element, the corresponding electrical coupling element of the auxiliary station, and the electrical receptor of the auxiliary station.

2. The docking system of claim 1, wherein each of the plurality of data storage components includes a cartridge housing the non-tape data storage media.

3. The docking system of claim 2, wherein the non-tape data storage media includes a hard disk drive.

4. The docking system of claim 1, wherein the auxiliary station is only able to communicate with the host computing device via the primary station.

5. The docking system of claim 4, wherein the primary station includes at least one primary station socket configured to receive and communicate with one of the plurality of data storage components.

6. The docking system of claim 1, wherein the primary station includes a processor configured to redundantly store data from the host computing device to the plurality of data storage components.

7. The docking system of claim 6, wherein the processor is configured to store data to the plurality of data storage components in a RAID storage scheme.

8. The docking system of claim 1, wherein the at least one socket is one of a plurality of sockets defined by the docking system, and wherein the primary station includes a processor configured to represent each of the plurality of data storage components received by the plurality of sockets to the host computing device as an independent drive.

9. The docking system of claim 8, wherein any one of the plurality of data storage components can be independently removed and/or inserted into one of the plurality of sockets of the docking system without affecting the any other one of the plurality of data storage components received by the docking system.

10. The docking system of claim 1, wherein the primary station additionally includes a power interface configured to be coupled with a power supply.

11. The docking system of claim 1, wherein the auxiliary station is a first auxiliary station, the docking system further comprising a second auxiliary station selectively coupled with the first auxiliary station and including a second plurality of sockets each configured to selectively receive, support, and communicate with one of the plurality of data storage components, the second auxiliary station being in communication with the primary station via the first auxiliary station only.

12. The docking system of claim 1, wherein the electrical connection device is the sole means of coupling the docking system with the host computing device.

13. A primary docking station for interfacing with a host computing device and configured to receive a data storage component including a non-tape data storage media and an electrical contact providing external access to the non-tape data storage media, the primary station comprising:
an electrical connection device configured to interface with the host computing device; and
a primary station socket configured to receive the data storage component and including an electrical interface configured to selectively interact with the electrical contact of the non-tape data storage media such that the host computing device can access the non-tape data storage media via the electrical connection device and the electrical interface.

14. The primary docking station of claim 13, wherein the primary station socket is one of a plurality of primary station sockets included in the primary docking station, and the data storage component is one of a plurality of data storage components, wherein each of the plurality of primary station sockets is configured to receive and to be electrically coupled with one of the plurality of data storage components; and
a processor configured to facilitate the host computer in reading data from and storing data to the ones of the plurality of data storage components received by the plurality of primary station sockets.

15. The primary docking station of claim 14, wherein the processor is configured to facilitate storage of data to and or reading data from the ones of the plurality of data storage components received by the plurality of primary station sockets using one of a RAID storage scheme and any other replicated data storage scheme.

16. The primary docking station of claim 14, wherein the processor is configured to represent each of the ones of the plurality of data storage components received by each of the plurality of primary station sockets as a separate storage drive.

17. The primary docking station of claim 13, further comprising:
a primary station electrical coupling element configured to be electrically coupled with an auxiliary docking station, wherein the auxiliary docking station includes at least one auxiliary socket each configured to receive and electrically communicate with one of the plurality of data storage components, and further wherein the primary station socket and the at least one auxiliary socket are each one of a plurality of system sockets collectively defined by the primary station and the auxiliary station; and
a processor configured to facilitate the host computer in reading data from and storing data to the plurality of data storage components received by the plurality of system sockets using one of a replicated data storage scheme and an individual drive basis.

18. An auxiliary docking station configured to be coupled with a primary docking station coupled with a host computing device, the auxiliary docking station being configured to receive a plurality of data storage components, each of the plurality of data storage components including a non-tape data storage media and an electrical contact providing external access to the non-tape data storage media, the auxiliary docking station comprising:
an electrical coupling element configured to be selectively coupled with a primary station electrical coupling element of the primary docking station;
at least one socket configured to selectively receive one of the plurality of the data storage components; and
an electrical receptor positioned within each of the at least one socket and being configured to interface with the electrical contact of the one of the plurality of data storage components received by each of the at least one socket,
wherein the auxiliary docking station is configured such that the host computing device can access the non-tape data storage media via the primary station and the auxiliary docking station.

19. The auxiliary docking station of claim 18, wherein the plurality of data storage components each include a cartridge housing the non-tape data storage media, and the non-tape data storage media includes a hard disk drive.

20. The auxiliary docking station of claim 18, including an auxiliary electrical coupling element on a side of the auxiliary docking station opposite the electrical coupling element, the auxiliary electrical coupling element being configured to receive a second auxiliary docking station.
